(19) United States
(12) Patent Application Publication
(10) Pub. No.: US 2008/0117645 A1
(43) Pub. Date: May 22, 2008

(54) VEHICLE HEADLIGHT SHIELD

(75) Inventors: Rick Ladbury, Idanha, OR (US); George Louis McGregor, Idanha, OR (US); Keith A. Paasch, Idanha, OR (US)

Correspondence Address: Stolowitz Ford Cowger LLP, 621 SW Morrison St, Suite 600, Portland, OR, 97205, US

(73) Assignee: Ladbury Enterprises, Idanha, OR (US)

(21) Appl. No.: 11/858,865

(22) Filed: Sep. 20, 2007

Related U.S. Application Data
(60) Provisional application No. 60/826,357, filed on Sep. 20, 2006.

(51) Int. Cl. F21V 1/22; F21V 15/04

(52) U.S. Cl. 362/509; 362/376

(57) ABSTRACT

A vehicle headlight shield protects a headlight of an off-road (or other) vehicle such as an ATV, motorcycle, or other vehicle, to reduce the chance of the headlight cracking, chipping or breaking.

### CROSS REFERENCE RELATED APPLICATIONS

This application claims priority from U.S. provisional application No. 60/826,357, filed Sep. 20, 2006, which is incorporated herein by reference.

### BACKGROUND OF THE INVENTION

Off-road vehicles such as All Terrain Vehicles (ATVs) and motorcycles are frequently driven on unpaved surfaces. Rocks and other materials are sometimes kicked up from the unpaved surfaces at great velocity. When these materials hit a glass or plastic headlight on the off-road vehicle, the glass or plastic may chip, crack or even shatter. The disclosure that follows solves this and other problems.

### SUMMARY OF THE INVENTION

A vehicle headlight shield protects a headlight of an off-road (or other) vehicle such as an ATV, motorcycle, or other vehicle, to reduce the chance of the headlight cracking, chipping or breaking.

### BRIEF DESCRIPTION OF THE DRAWINGS

FIG. 1 illustrates an off-road vehicle with an attached vehicle headlight shield.

FIG. 2A illustrates a front view of the vehicle headlight shield shown in FIG. 1.

FIG. 2B illustrates a side view of the vehicle headlight shield shown in FIG. 1.

FIG. 3 illustrates a function of the pads included on the vehicle headlight shield shown in FIG. 1.

FIG. 4 illustrates a function of the bend included on the vehicle headlight shield shown in FIG. 1.

### DETAILED DESCRIPTION

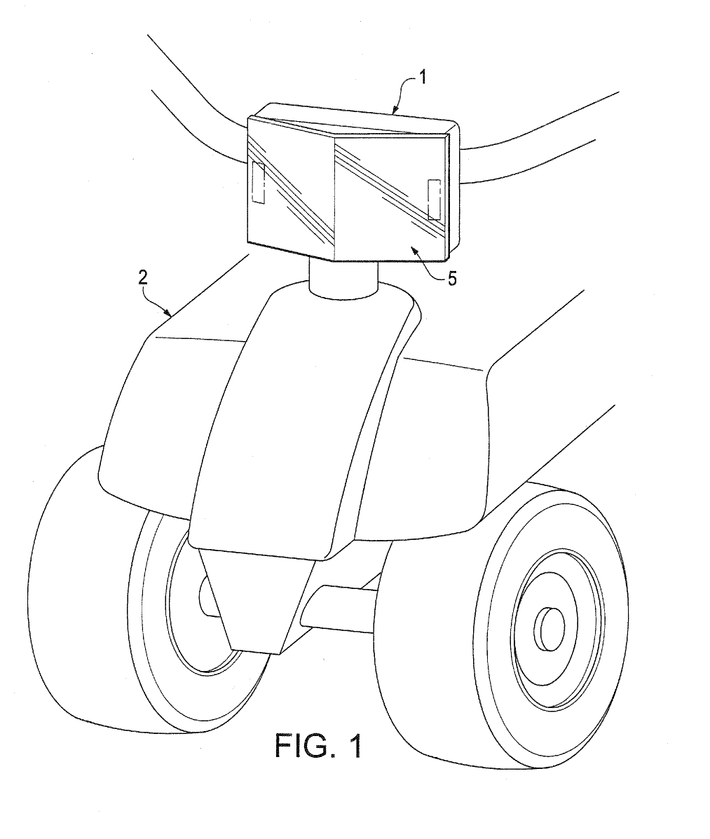

Referring to FIG. 1, the vehicle headlight shield 5 attaches to a headlight 1 of an off-road vehicle, such as ATV 2. In the present example, the vehicle headlight shield 5 is made out of Lexan polycarbonate, which is more resistant to chipping, cracking and shattering than glass or other materials used in headlight 1. In other examples, the vehicle headlight shield 5 may be made out of any other shatterproof and transparent or translucent material. In other embodiments, the shield 5 may attach to any part of the ATV 2 to protect the headlight 1.

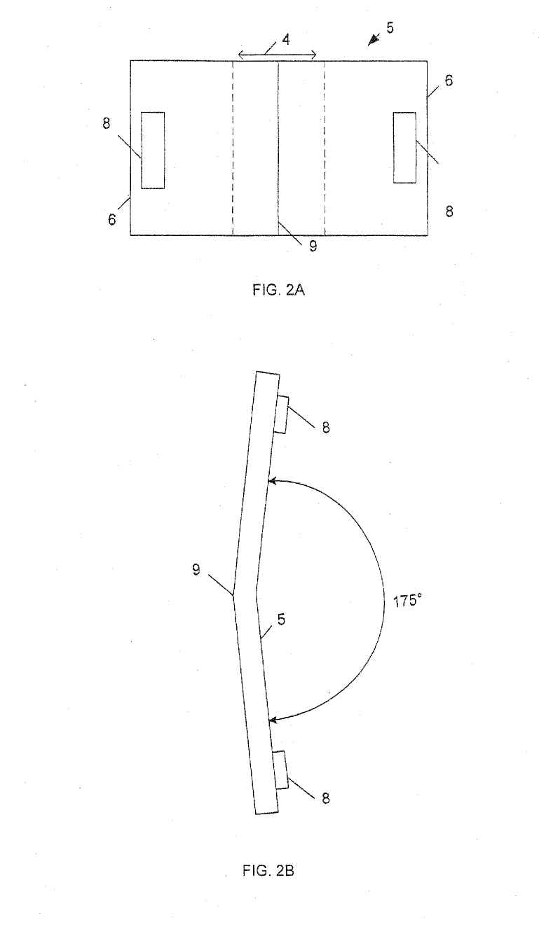

FIG. 2A is a front view of the vehicle headlight shield 5 illustrated in FIG. 1. The vehicle headlight shield 5 may include a bend 9 causing a center portion 4 to be more forwardly disposed than ends 6. The protrusion of the center portion 4 produces a triangular shaped cavity located between a headlight and the center portion 4 of an attached vehicle headlight shield 5. As will be explained in greater detail with respect to FIG. 4, the cavity reduces the chance of a crack on the vehicle headlight shield 5 or the headlight. In the present example, the bend 9 is five degrees, which produces a 175 degree angle on a back of the vehicle headlight shield 5. Of course, bends of different degrees, such as between 0-90 degrees, are also within the contemplation of this invention. The bend can also be located at any desired location along the headlight shield, but is most preferably located near a center line of the device. When the bend 5 is selected to be oriented vertically as shown, debris is generally deflected to the sides of the vehicle instead of over/under the vehicle.

Referring to FIG. 2B, the forward disposition of the center portion 4 relative to the ends 6 also reduces the chance of a rock hitting the vehicle headlight shield 5 perpendicularly, which decreases the chance of damage to the vehicle headlight shield 5 or the headlight. In other words, rocks have a greater chance of being deflected, which reduces cracking of the vehicle headlight shield 5 or glass behind the vehicle headlight shield 5. The area between the vehicle headlight shield 5 and the headlight provided by the bend also provides a buffer, which allows the shield 5 to flex and cushion the impact from a rock or other object without striking the headlight. This flexing effect is explained in greater detail with respect to FIG. 4.

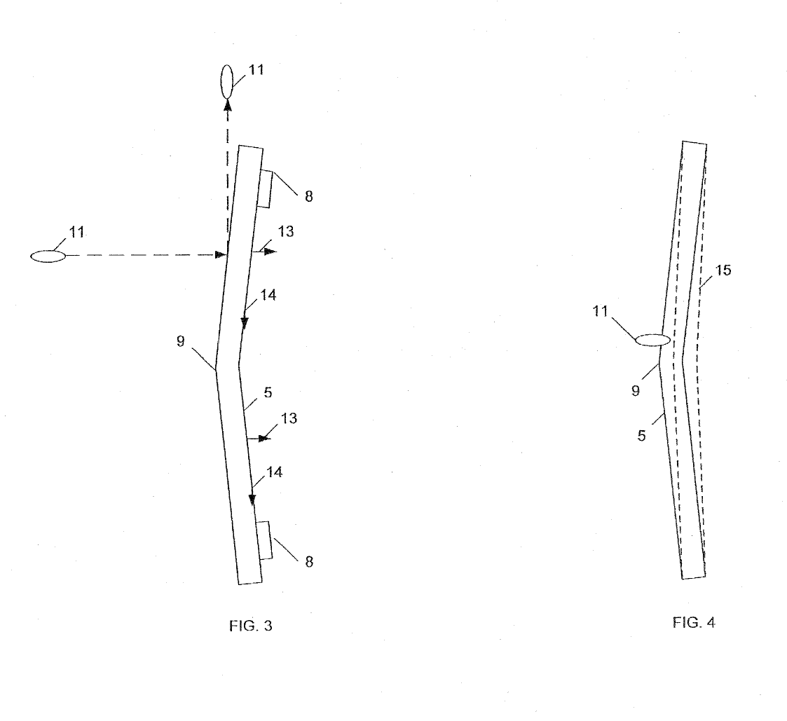

Still referring to FIG. 2B, the vehicle headlight shield 5 also includes pads 8 disposed on the ends 6 for detachably coupling the shield 5 to a vehicle or headlight. In the present example, the pads 8 are arranged as two fastening strips located on a back of the vehicle headlight shield 5. In other examples, the pads 8 may be arranged as four or more fastening dots located on the back of the vehicle headlight shield 5. Other arrangements are also possible and practical. One function of the pads 8 is explained in greater detail with reference to FIG. 3

Referring to FIG. 3, the pads 8 also operate to decrease the chance of a rock breaking the vehicle headlight shield 5 or glass behind the vehicle headlight shield 5. In the present example, the pads 8 can be made out of a highly compressible material. When a rock 11 hits the vehicle headlight shield 5, the pads 8 compress causing the vehicle headlight shield 5 to respond to the impact by moving backwards as shown by directional arrows 13. The backwards movement of the vehicle headlight shield 5 towards the headlight dissipates the energy of the rock 11, which decreases the chance of breakage. The pads 5 preferably have a compressibility of at least 2×10⁻⁶ β (m²N).

In the present example, the pads 8 can be also made out of a flexible material. The selection of a non-rigid material creates a “spongy” effect that allows an attached vehicle headlight shield 5 to move slightly upwards, downwards or sideways in response to an impact. This lateral movement produces a rocking effect that augments the benefit of the bend 9 in reducing cracking. For example, when the rock 11 approaching from the forward direction hits the vehicle headlight shield 5, not only is the rock 11 deflected due to the bend 9, the vehicle headlight shield 5 also moves sideways as indicated by the directional arrows 14. This rocking effect further dissipates the energy of the rock 11, which decreases the chance of breakage.

Thus, to summarize, the example vehicle headlight shield 5 has several features that decrease the chance of breakage. First, the vehicle headlight shield 5 is made out of a resilient material such as polycarbonate or another material that is more resistant to cracks than the front surface of the headlight. Second, the vehicle headlight shield 5 includes the bend 9, which provides deflection and may also create a cavity between the headlight and the shield 5. Third, the pads 8 are made out of a compressible material, which allows the vehicle headlight shield 5 to move backwards in response to a hit. Fourth, the pads 8 can be made out of a non-rigid material that provides a spongy effect allowing movement in response to a hit. In other examples, only some of these features are included in a vehicle headlight shield. For example, other vehicle headlight shields may include a bend but not the flexible, compressible pads. Alternatively other vehicle headlight shields may omit the bend, but still include the flexible, compressible pads. In yet other embodiments, any attachment structure is used instead of the pads and may be either compressible or flexible, both or neither.

Other features of the pads 8 include allowing the vehicle headlight shield 5 to be quickly detachably coupled from a headlight. The detachably coupling feature allows the vehicle headlight shield 5 to be removed from the headlight for cleaning of the vehicle headlight shield 5 and the headlight. Also, when the headlight burns out, the vehicle headlight shield 5 may be removed and attached to a replacement headlight. If the vehicle headlight shield 5 were to be cracked due to mishandling, the pads 8 allow for replacement on the same headlight.

In some examples, the pads 8 are made out of double sided foam tape, which can be used in varying thicknesses to vary compressibility or sponginess. When the double sided foam tape is used, the highly compressible foam compresses when the shield 5 is hit by an object, dampening the transfer of energy from the rock to the headlight. The thickness of the pads 8 may be one eighth inch, or any other thickness selected to form a space between the shield 5 and the headlight.

It should be appreciated that the thickness of the double sided foam tape affects the amount of space between the shield 5 and the headlight. For example, while the triangular shaped cavity formed by the bend allows the center portion 9 to flex in response to a hit without contacting the headlight, the thickness of the double sided foam can be varied to affect the size of a space between the shield 5 and the headlight. The size of the space can be selected to prevent the end regions from recoiling and hitting the headlight responsive to a hit.

In other examples, the pads 8 include fibrous material that engages a multitude of fastening hooks glued to the headlight (or visa versa). When fastening hooks are used, increasing the length or reach of the fastening hooks increases sponginess and compressibility and also increases the size of the space between the shield 5 and the headlight.

In yet other examples, the vehicle headlight shield includes other quick attachment structure besides pads 8, such as eyes for attaching screws or wing nuts. Steel screws can be used, but screws made out of plastic, rubber or other materials having a higher compressibility than steel are preferred. The length of the screws should be selected to vary the space between the shield 5 and the headlight, which accommodates recoil.

Referring to FIG. 4, the benefit of the cavity produced by the bend 9 and a headlight is illustrated. When the rock 11 hits the flexible vehicle headlight shield 5, the cavity allows the vehicle headlight shield 5 to temporarily flex and travel backwards, as illustrated by the dashed lines 15. This backwards movement greatly reduces the amount of energy transferred from the vehicle headlight shield 5 to the headlight, which reduces the chance of breaking the glass. The backwards movement also dissipates the energy of the rock, which reduces the chance of cracking the vehicle headlight shield 5.

Although the cavity is produced by the bend 9 in the present example, any other formation may be used to produce a cavity between the vehicle headlight shield 5 and the glass. For example, in other embodiments the vehicle headlight shield is curved outwardly with respect to the headlight, which produces a cavity. In yet other examples, the ends of the vehicle headlight shield 5 are thickened, which produces a cavity to accommodate flexing. Any method of creating a buffer between the shield and a headlight can be used, however.

The vehicle headlight shield 5 illustrated in FIGS. 1-4 is clear, but in other examples may be tinted with color. The tinting can be used to change the color of the beam produced by the headlight, allowing a rider to switch beam colors simply by changing vehicle headlight shields. Changing the light beam color provides advantages beyond aesthetic reasons, such as allowing one rider to easily distinguish between other riders based on beam color and in some instances improved visibility depending on weather and lighting conditions. The color or the pads may be selected to correspond to the beam color, which allows a rider to easily identify, prior to attachment, which shield produces which beam color.

The tinting can also be used to change the appearance of front of the ATV without substantially affecting the beam color. For example, on a yellow ATV a person may attach vehicle headlight shields with a slight yellow tint so as to produce an all-yellow color theme for the ATV.

The pads on the vehicle headlight shield 5 illustrated in FIGS. 1-4 are preferably Velcro with a color selection based on a brand of the ATV. For example, for a Honda ATV the Velcro pads can be colored Honda red, for a Suzuki ATV the Velcro pads can be colored Suzuki yellow, etc. In other examples, coloration of the attaching structure varies and is not required.

Having described and illustrated the principles of the invention in a preferred embodiment thereof, it should be apparent that the invention can be modified in arrangement and detail without departing from such principles. For example, the vehicle headlight shield may be contoured to detachably coupled to a variety of headlights, whether they include a rectangular shape and a flat surface, a rounded surface, a tear drop shape, etc. Other adaptations required to fit the vehicle headlight shield onto various brands of headlights are also possible. Also, a center portion of the shield can extend outwardly without using a bend, but instead using a curve or other structure providing the protrusion or bulge of a non-end portion relative to the ends. I claim all modifications and variation coming within the spirit and scope of the following claims.

1. A transparent or translucent plastic material for detachably coupling to an off-road vehicle headlight, the plastic material comprising:
a center portion and a plurality of end portions;
a bend causing the center portion to be more forwardly disposed than the end portions when the plastic material is detachably coupled to the off-road vehicle headlight, the bend forming a triangular shaped cavity between the plastic material and the headlight;
an attachment region located on a back surface of the plastic material; and
a compressible attachment structure formed on the attachment region for detachably coupling the plastic material to the headlight, the compressible attachment structure having a thickness selected to provide a space between the back surface and the headlight when the plastic material is detachably coupled to the headlight.

2. The transparent or translucent plastic material of claim 1 wherein the triangular recess allows the center portion to flex responsive to an impact.

3. The transparent or translucent plastic material of claim 2 wherein the space allows the plastic material to recoil responsive to the impact.

4. The transparent or translucent plastic material of claim 3 wherein the compressible attachment structure is formed using a flexible component, the flexible component allowing the plastic material to respond to an impact by making movement in a lateral direction relative to the headlight.

5. The transparent or translucent plastic material of claim 4 wherein the flexible component is double sided foam tape.

6. The transparent or translucent plastic material of claim 4 wherein the flexible component comprises plastic hooks or fibrous loops selected to mate with fibrous loops or plastic hooks fixed on the headlight.

7. The transparent or translucent plastic material of claim 4 further comprising a tint that alters the color of a beam of light originating from the headlight and passing through the plastic material.

8. The transparent or translucent plastic material of claim 7 wherein a color of the flexible component is selected to correspond to the color of altered light beam.

9. A headlight shield for protecting a headlight of a vehicle from impacts, the shield comprising:
means for attaching the shield to the vehicle to protect the headlight, said attaching means forming a space between at least portions of a back surface of the shield and the headlight;
means for forming an outward protrusion of a front surface of the shield relative to edge portions of the shield; and
means for dampening a first amount of energy associated with an impact to the shield, the dampening means allowing only a second smaller amount of energy to be transferred to the headlight.

10. The headlight shield of claim 9 wherein the attaching means is flexible such that the headlight shield responds to the impact by moving laterally relative to the headlight.

11. The headlight shield of claim 9 wherein the outward protrusion provides an angle of deflection.

12. The headlight shield of claim 9 further comprising means for allowing the headlight shield to flex responsive to the impact.

13. An apparatus, comprising:
a front surface for protecting at least portions of a vehicle headlight, the front surface having an outwardly extending region;
a back surface having at least one attachment region for attaching to a vehicle;
an attachment structure located at the attachment region for detachably coupling the apparatus to the vehicle;
wherein the attachment structure is compressible such that the back surface makes movement toward the headlight responsive to an impact to the front surface.

14. The apparatus of claim 13 wherein the attachment structure is flexible such that the apparatus responds to the impact by making lateral movement relative to the vehicle.

15. The apparatus of claim 13 wherein a contour of the apparatus is configured to form a space between the back surface and the headlight when the apparatus is detachably coupled to the vehicle, the space allowing the back surface to make movement toward the headlight separate from movement attributable to compression of the attachable structure.

16. The apparatus of claim 13 wherein a portion of the back surface that corresponds to the outwardly extending region of the front surface is concave, the concave portion forming a cavity allowing the apparatus to flex backwards responsive to the impact.

17. The apparatus of claim 13 wherein the attachment structure defines through-holes for receiving a screw having a composition material exceeding the compressibility of steel.

18. The apparatus of claim 13 wherein the attachment structure is comprised of velcro.

19. The apparatus of claim 13 wherein the apparatus further comprises a five degree bend, the five degree bend corresponding to the outwardly extending region of the front surface.

20. The apparatus of claim 13 wherein the front and back surfaces are formed using polycarbonate.

21. The apparatus of claim 21 wherein the back surface defines a triangular shaped opening.
